(19) United States
(12) Patent Application Publication
(10) Pub. No.: US 2007/0146763 A1
(43) Pub. Date: Jun. 28, 2007

(54) Printing control device and printing control method

(75) Inventor: Kazuyuki Yokoyama, Matsumoto-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/644,194

(22) Filed: Dec. 21, 2006

(30) Foreign Application Priority Data
Dec. 27, 2005 (JP) 2005-373913

(51) Int. Cl. G06F 3/12

(52) U.S. Cl. 358/1.13

(57) ABSTRACT

A printer driver causes a printer to print based on print conditions defined before printing starts and a print command asserted by a particular application, and a registry stores a plurality of different print conditions. The plural print conditions stored in the registry are linked to printer paper identification information. The printer driver searches the plural print conditions stored in the registry to find the print conditions corresponding to the same identification information as the printer paper identification information in the print command, changes the preset print conditions according to the found print conditions, and then causes the printer to print.

The present application claims priority from Japanese Patent Application JP 2005-373913 filed on Dec. 27, 2005, which is hereby incorporated by reference in its entirety.

### BACKGROUND OF THE INVENTION

1. Technical Field

The present invention relates to technology for automatically changing printing settings to the print conditions contained in a print request in order to print after receiving a print request from an application.

2. Related Art

In order to obtain the desired printer output when printing from a printer, the user must appropriately set various print conditions such as the paper size, number of copies, and print quality. This typically requires the user to open a print configuration screen provided by the printer driver and set particular printing parameters as desired before starting to print.

As printer functionality has improved, the number of configurable print conditions has also increased while each configurable option may also afford a range of settings. Setting these various options each time something is printed therefore requires a somewhat complicated operation, which increases the burden on the user accordingly. Addressing this problem Japanese Unexamined Patent Appl. Pub. 2005-135343 teaches technology for reading the predefined settings for a plurality of printing options defined in the print conditions to change the print driver setup.

While the technology taught in Japanese Unexamined Patent Appl. Pub. 2005-135343 eliminates the need to reset the print conditions every time something is printed, changing the settings stored in the print conditions requires reading the stored settings and thus requires user intervention. The problem, therefore, is that the print conditions cannot be changed automatically to match the print conditions contained in a print request received from an application without user intervention.

The present invention provides technology for printing according to the desired print conditions contained in a received print request without requiring user intervention.

### SUMMARY

To achieve this object, a printing control device according to a preferred aspect of at least one embodiment of the invention has a control unit for causing a printer to print based on print conditions that are preset in advance of printing and a print request generated by a particular application, and a storage unit for storing a plurality of different print conditions. The plural print conditions are stored in the storage unit correlated to identification information (unique information) for the printer paper. The control unit searches the plural print conditions stored in the storage unit to find the print conditions that are linked to the same identification information as the printer paper identification information from the print request, changes the preset print conditions according to the identified print conditions, and then causes the printer to print.

The print settings can therefore be changed automatically to the print conditions matching the print command from the application and printing can proceed with no further user action.

Preferably, the printing control device also has a display control unit for controlling the configuration screen that receives the print condition configuration request. When a configuration request is received through the configuration screen, the control unit can add to, update, or delete particular print conditions in the storage unit.

A printing system according to another preferred aspect of at least one embodiment of the invention has a display device for displaying the configuration screen, an input device for entering the print conditions, a printer for printing, and the printing control device of the invention.

Yet further preferably, the printer paper identification information is information identifying the paper size or paper type.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a function block diagram of a printing system according to a preferred embodiment of the invention.

FIG. 2 shows an example of a printer setup screen.

FIG. 3 is a flow chart of a procedure for changing the print conditions.

FIG. 4 is a flow chart of the printing process.

FIG. 5 is a flow chart of the printing process.

### DESCRIPTION OF EMBODIMENTS

A preferred embodiment of the present invention is described below with reference to the accompanying figures.

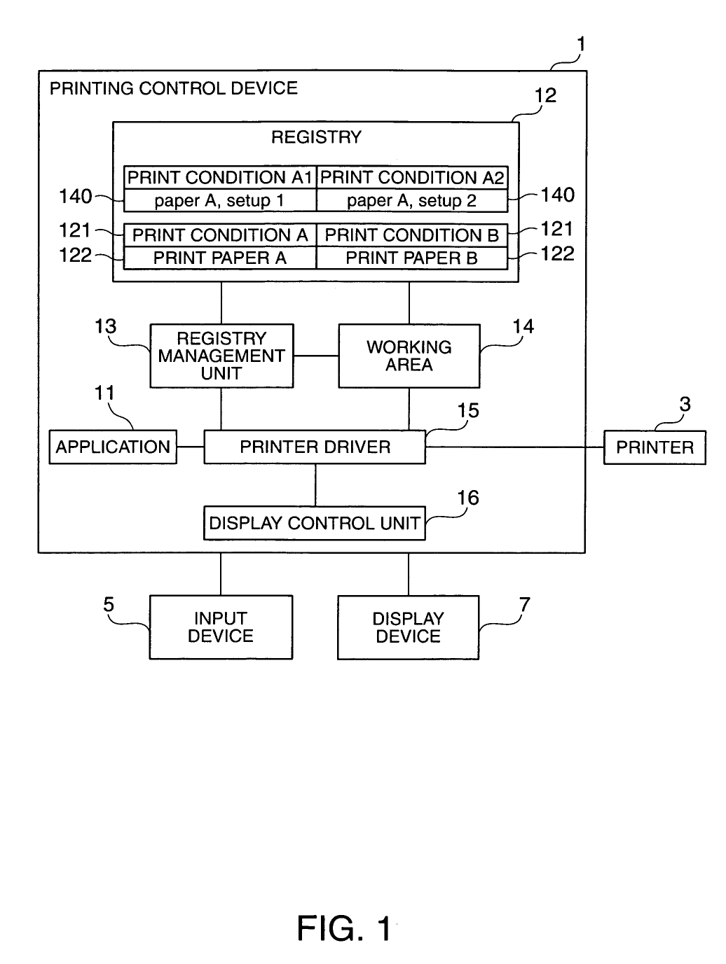

FIG. 1 is a function block diagram of a printing system according to a preferred embodiment of the invention.

This printing system includes a printing control device 1 and a printer 3. An input device 5 and a display device 7 are connected to the printing control device 1.

The printing control device 1 can be used with a common personal computer, and the functions and elements of the printing control device 1 described below can be performed by executing a computer program that is stored in a storage device or a storage medium not shown.

As also shown in FIG. 1, the printing control device 1 includes an application 11 that issues print requests, a registry 12, a registry management unit 13, working area 14, printer driver 15, and a display control unit 16.

The registry 12 stores a plurality of print condition groups, each group containing settings for particular print conditions.

The registry management unit 13 manages the print condition groups stored in the registry 12.

The working area 14 temporarily stores the print condition settings for processing.

The printer driver 15 reads the print condition settings stored in the working area 14 and drives the printer 3 based on those settings and the print request.

The display control unit 16 presents specific display screens on the display device 7 and receives input from the input device 5.

The registry 12 stores a plurality of print condition groups 121 linked to a particular printer paper name 122.

Each print condition group 121 contains settings for particular printing options that can be used when printing with the printer 3. These printing options include, for example, the name (type) of paper, the printing direction (page orientation), number of copies, resolution, printing speed, print quality, and black-and-white or color printing selection. The printer paper name 122 could be, for example, postcard, roll paper, US letter, A4, inkjet paper, thermosensitive paper, thermal transfer paper, label paper, and slip, and the printer paper name 122 can thus indicate the size of paper, the type of paper, or a combination of both. The printer paper name 122 can also be an item in the print condition group 121.

The registry management unit 13 handles copying print condition settings contained in the print condition groups 121 stored in the registry 12 to working area 14, by saving the print condition settings configured in working area 14 as a new print condition group 121 in the registry 12, and updating and deleting existing print condition groups 121.

The working area 14 stores the settings and printer paper name 122 contained in each print condition group 121.

The printer driver 15 causes the printer 3 to print based on the print conditions defined by the predefined settings of the various printing options. The default values of the various printing options are set to standard print conditions, but the default values can be changed as described further below. More specifically, when a print request is received from an application 11, the printer driver 15 changes the settings of specific print options to the settings stored in the working area 14 to drive the printer 3.

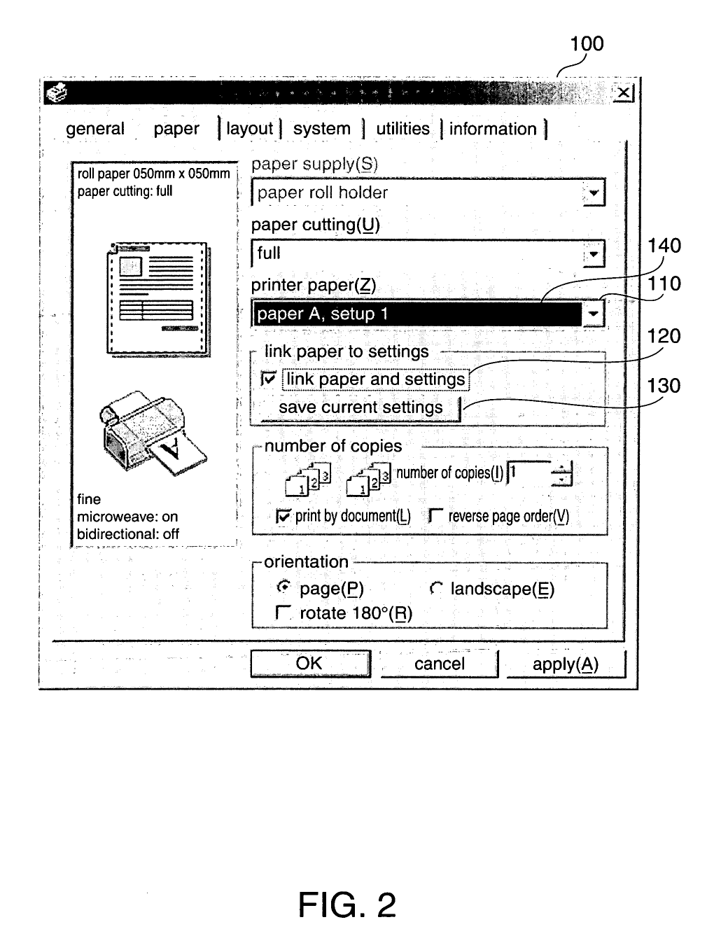

The display control unit 16 presents a specific user interface screen on the display device 7. For example, the display control unit 16 presents the printer configuration screen shown in FIG. 2 on the display device 7 and receives data input to the configuration screen from a mouse, keyboard, or other input device 5.

FIG. 2 shows an example of a printer configuration screen 100.

This printer configuration screen 100 has areas for setting a plurality of printing options. In this example the printer configuration screen 100 has a paper name selection area 110, a paper name linking selection area 120 for selectively linking a paper name with the print settings, and a save button 130 for storing the current print settings.

The paper name selection area 110 can be a pull-down list such as shown in the figure enabling the user to select one of a plurality of predefined names.

The paper name linking selection area 120 for selectively linking a paper name with the print settings can be a checkbox as shown in the figure for selectively linking the print settings to the paper name selected by the paper name selection area 110. If the paper name linking selection area 120 is checked so that the selected paper name is to be linked to the current print settings, the print settings are changed to the settings specified by the print condition group linked to the paper name selected by the paper name selection area 110 for printing. If the paper name linking selection area 120 is not checked so that the paper name and print settings are not linked, printing proceeds using the default settings, standard settings, or the current user-defined settings.

When the save button 130 is pressed, the settings for the print conditions set by the printer driver 15 are written from the working area 14 to the registry 12.

A user-defined custom paper definition function (shown as reference numeral 140 in FIG. 1/2) can also be used to create additional paper types for selection by the paper name selection area 110, and the custom paper type can be linked to specific print settings. This enables the user to define different print options for the same size or type of paper and save those combinations as “paper A, setup 1” and “paper A, setup 2,” for example, so that multiple different printer settings can be configured for use with the same type of paper.

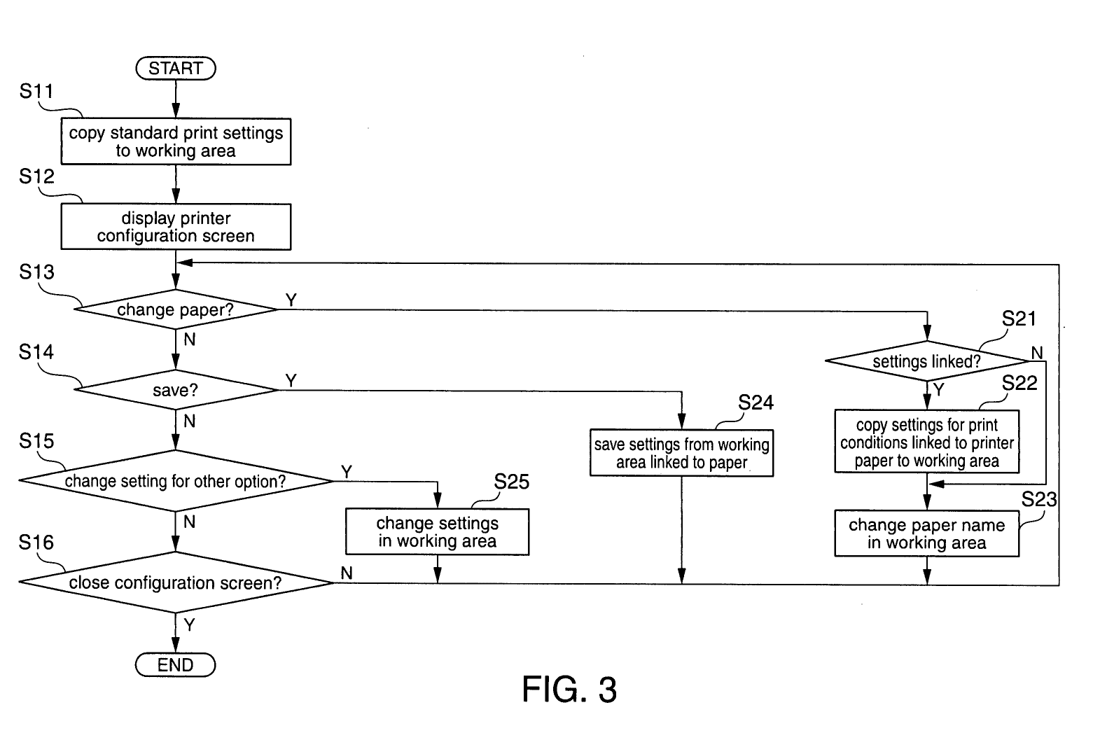

The printing process of this printing control device is described next with reference to the flow chart in FIG. 3.

FIG. 3 is a flow chart of the process for changing the print conditions in response to user input received through the printer configuration screen 100.

The registry management unit 13 first copies the standard settings for the various print conditions from the registry 12 to the working area 14 (S11).

The display control unit 16 then presents the printer configuration screen 100 on the display device 7 (S12).

If a paper name is selected by the paper name selection area 110 when the printer configuration screen 100 is displayed on the display device 7 (S13 returns Yes), the registry management unit 13 determines if the paper name linking selection area 120 is set to “link” the paper name with the print settings (S21). If the paper name is to be linked (S21 returns Yes), the registry management unit 13 finds the print condition group 121 corresponding to the printer paper name 122 selected by the paper name selection area 110 from among the print condition groups 121 stored in the registry 12, and copies the settings in that group to the working area 14 (S22).

If the paper name is not linked (S21 returns No), step S22 is skipped.

The printer paper name 122 in the working area 14 is then changed to the paper name selected by the paper name selection area 110.

If the paper name is not changed in step S13 (S13 returns No), whether the save button 130 was pressed is determined (S14). If the save button 130 was pressed (S14 returns Yes), the paper name and the settings of the print conditions currently set in the working area 14 are saved to the registry 12 (S24). If the same paper name is already saved in the registry 12, the settings for that paper name are overwritten. If the same paper name does not exist, a new one is created. The user could also be enabled to select whether to create a new paper name or overwrite the existing name. If an existing name is not needed, the name can also be deleted.

If the save button 130 was not pressed in step S14 (S14 returns No), whether the setting of any other print option was changed in the printer configuration screen 100 is determined (S15). If a change was made (S15 returns Yes), the registry management unit 13 changes the settings in the working area 14 accordingly (S25).

Steps S13 to S16 thereafter repeat until the printer configuration screen 100 is closed (S16).

This process enables saving and updating print condition groups in the registry 12.

The printing process is described next.

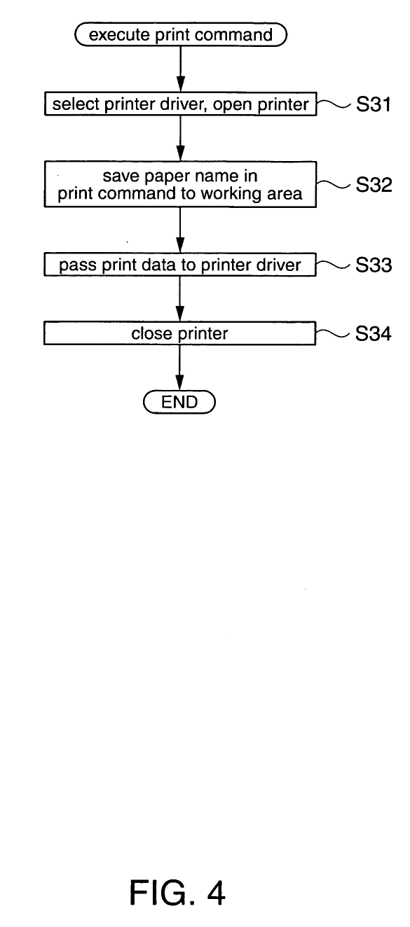

FIG. 4 is a flow chart of the printing process executed when the application 11 and registry management unit 13 issue a print command.

The application 11 first selects a printer driver 15 and opens the printer 3 control function (S31). When the printer 3 control function is opened the registry management unit 13 retrieves and copies the standard print settings from the registry 12 to the working area 14.

The application 11 changes only the paper name in the working area to the paper name linked to the print settings for the print job (S32).

The application 11 then passes the print data, such as the images or text to be printed, to the printer driver 15 and closes the printer 3 control function (S33, S34).

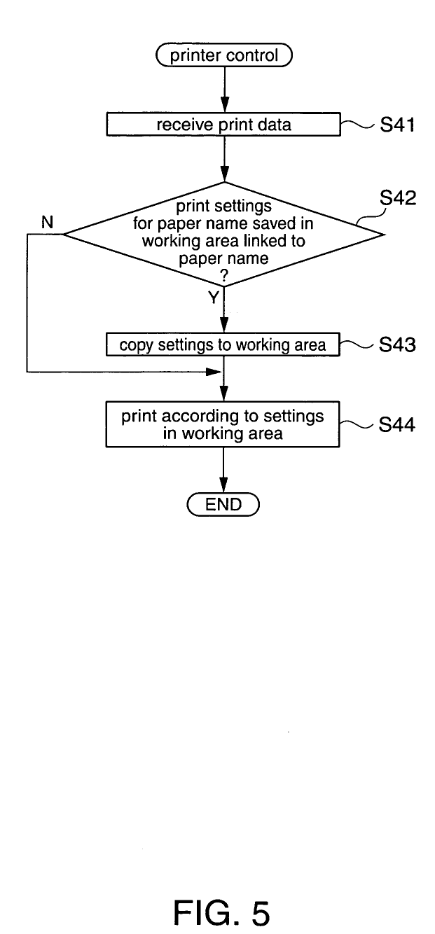

FIG. 5 is a flow chart of the process executed by the printer driver 15 and registry management unit 13 when the printer driver 15 receives a print command.

The printer driver 15 first receives print data from the application 11 (S41). The registry management unit 13 then references the registry 12 based on the instructions from the printer driver 15, finds the group linked to the paper name stored in the working area 14, and determines if the paper name linkage setting of that group is enabled (S42).

If the group is linked (S42 returns Yes), the registry management unit 13 copies the settings in that group to the working area 14 (S43).

If the group is not linked (S42 returns No), step S43 is skipped, the print settings are configured according to the settings stored in the working area 14, and the print data is printed (S44).

The printer driver 15 outputs commands for controlling the printer 3 based on the print settings and the print data. The printer driver 15 sends the print command and print data to the printer 3 to print.

The print control method shown in the flow charts in FIG. 4 and FIG. 5 can be realized as a computer program executed by the printing control device 1 shown in FIG. 1.

The invention thus enables printing according to the desired print conditions corresponding to a particular print command with no user intervention.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A printing control device comprising:
a control unit for causing a printer to print based on print conditions that are preset in advance of printing and a print request generated by a particular application; and
a storage unit for storing a plurality of different print conditions;
wherein the plurality of different print conditions are stored in the storage unit and are correlated to identification information for a printer paper;
the control unit searches the plurality of different print conditions stored in the storage unit to find print conditions that are linked to the identification information for printer paper from a print request, changes the preset print conditions according to the identified print conditions, and then causes the printer to print.

2. The printing control device described in claim 1, further comprising:
a display control unit for controlling a configuration screen that receives print condition configuration requests;
wherein when the control unit receives a configuration request through the configuration screen, the control unit adds, updates, or deletes particular print conditions in the storage unit.

3. The printing control device described in claim 1, wherein the printer paper identification information is information identifying one of the paper size and paper type.

4. A printing system comprising:
a display device for displaying the configuration screen;
an input device for entering the print conditions;
a printer for printing; and
the printing control device described in claim 2.

5. A printing control method for causing a printer to print based on print conditions that are preset in advance of printing and a print request generated by a particular application; the printing control method comprising:
storing a plurality of different print conditions correlated to printer paper identification information in a storage unit;
searching the plurality of print conditions stored in the storage unit to find print conditions that are linked to the identification information for printer paper from a print request; and
changing the preset print conditions according to the identified print conditions, and then causing the printer to print.

6. A computer program rendering a printing control device for causing a printer to print based on print conditions that are preset in advance of printing and a print request generated by a particular application, the computer program executing a printing control process comprising:
storing a plurality of different print conditions correlated to printer paper identification information in a storage unit;
searching the plurality of different print conditions stored in the storage unit to find print conditions that are linked to the identification information for printer paper from a print request; and
changing the preset print conditions according to the identified print conditions, and then causing the printer to print.

7. The computer program described in claim 6, wherein the step of causing the printer to print is executed by a printer driver.

8. The printing control device of claim 1, further including a user-defined custom paper definition unit that defines different print options for a same paper size or type of paper.

9. The printing control device of claim 1, further including a paper name linking selection area, wherein the control unit changes the present print conditions when the paper name linking selection area is selected.

10. The printing control method of claim 5, further including defining different print options for a same paper size or type of paper.

11. The printing control method of claim 5, further including changing the present print conditions when the paper name linking selection area is selected.

12. The computer program of claim 6, wherein the printing control process defines different print options for a same paper size or type of paper.

13. The computer program of claim 6, wherein the printing control process changes the present print conditions when the paper name linking selection area is selected.
